(19) United States
(12) Patent Application Publication
(10) Pub. No.: US 2004/0246711 A1
(43) Pub. Date: Dec. 9, 2004

(54) Apparatus and method for flameless burning of candles

(76) Inventors: Rachel Brenchley, Providence, UT (US); Greg Brenchley, Providence, UT (US); Linda Thatcher, Logan, UT (US); Sid Thatcher, Logan, UT (US); Lee Tibbits, Millville, UT (US)

Correspondence Address: RANDALL B. BATEMAN, BATEMAN IP LAW GROUP, 4 TRIAD CENTER, SUITE 825, PO BOX 1319, SALT LAKE CITY, UT, 84110, US

(21) Appl. No.: 10/787,533

(22) Filed: Feb. 26, 2004

Related U.S. Application Data
(63) Continuation-in-part of application No. 09/861,324, filed on May 18, 2001, now abandoned.

(51) Int. Cl. F21L 19/00

(52) U.S. Cl. 362/161

(57) ABSTRACT

A method and apparatus for flameless “burning” of a candle includes placing a candle on a heating element so that the candle wax melts and emits the fragrance with which the candle has been scented. By not burning the candle, the candle wax will last considerably longer and the candle can be readily replenished with additional wax and/or fragrance. Additionally, light can be emitted above, below or within the candle to provide a desired effect.

### BACKGROUND OF THE INVENTION

1. Field of the Invention

The present invention relates to an apparatus and method for “burning” of candles in which the candle wax is not consumed by flame. More particularly, the present invention relates to an apparatus and method by which candles are heated so as to emit fragrance without flame and the accompanying risks that burning candles may raise.

2. State of the Art

The burning or boiling of items to emit fragrant aromas has been practiced for many centuries. For example, incense has been burned to produce pleasing fragrances since near the beginning of recorded time. In many instances, the incense was burned as part of religious ceremonies. At other times, however, the incense was burned simply to give off pleasant odors, or to mask unpleasant odors.

While incense is still used, many people find the fragrances produced to be overwhelming. Additionally, burning incense creates smoke and has a tendency to make a room appear hazy. Thus, incense is most often used when a strong scent is desired to mask other odors.

Another common method for developing a fragrance in a room is to fill a small pot or dish with fragrant parts of a plants and spices. The items in the pot are then heated by a candle which helps to spread the pleasant fragrance. One concern with such a method of producing fragrance is that the pot must typically have some liquid to keep the contents from burning. If the liquid boils off, the contents of the pot can burn—thereby producing an offensive aroma. Additionally, the exposed candle poses a potential fire hazzard.

Yet another common method for creating scents within a room utilizes a mixture of dried flowers and spices. While packages of this potpourri are commonly available, they often are insufficiently strong after a short while to mask unpleasant odors. Additionally, the potpourri produces a lasting fragrance which can only removed by removing the potpourri. The user, however, may not desire the fragrance to be present at all times.

An increasingly popular method for masking odors or providing a pleasant fragrance in a room is the use of scented candles. Unlike potpourri which provides a fragrance which is nearly always present, the scent released by a candle can be controlled. If the scent is desired, the candle is lit and the burning flame causes the aroma to be released. By extinguishing the flame and covering the candle, the release of the candles scent is stopped. This is particularly beneficial in office environments and the like where the level fragrance must be controlled to avoid offending those who do not find the fragrance as enjoyable. Additionally, some individuals are sensitive to fragrance and may suffer from allergic reactions if the amount of fragrance is too great.

The use of candles resolves many of these concerns. By selectively lighting and extinguishing the candle, the amount of fragrance produced can be controlled. Additionally, the fragrance may be concealed until it is needed to mask unpleasant odors. Furthermore, scented candles generally produce less smoke than incense and are often less risky than use of a candle to heat a pot, as the scented candle is typically housed in a glass jar.

One problem which remains with scented candles, however, is that they still use a flame. While they are often safer than burning incense or other scent producing devices, the flame created while burning a scented candle can still cause fires. Thus, it is not uncommon to see restrictions on the use of scented candles in hotels and the like.

Another problem which can be created by the use of candles is the production of smoke. While the scented candles usually produce far less smoke than burning incense, the smoke generated by burning a scented candle can be sufficient to set off fire alarms or automatic sprinklers. Furthermore, prolonged use in the same location can result in smoke stains on walls and ceilings adjacent to the candle.

Still another problem with some scented candles is that the wick contains lead or other environmental pollutants. By burning the wick, lead or other toxic chemicals can be released into the air where they are likely to be inhaled by the user of the candle.

Still yet another problem with scented candles is that the candle often burns immediately around the wick, but leaves wax on the inside of the jar. In some situations, a considerable amount of wax can be left unusable because the wick has been exhausted.

In an attempt to remedy some of these concerns, some individuals have used coffee warmers to heat candles. The coffee warmer warms the candle wax sufficiently to produce the desired aroma, but does not create a fire hazzard. The use of a simple coffee warmer has limitations, however, because there is often no temperature control, and the candle may not fit the coffee warmer properly. Additionally, any contaminants which may be in the wick may leach into the candle wax.

Thus, there is a need for an improved mechanism for emitting scents to mask foul odors and to otherwise provide pleasant aromas without the disadvantages of the conventional mechanisms discussed above. Such an apparatus or method should be simple to use, should be safe, and should reduce the risk of fire associated with burning candles and the like.

### SUMMARY OF THE INVENTION

Thus, it is an object of the present invention to provide an apparatus and method for producing scents without burning the wick of a candle.

It is another object of the present invention to provide such an apparatus and method which provides for an increased life during which a candle emits desired fragrances.

t is yet another object of the present invention to provide such an apparatus and method which eliminates the fire and smoke hazzard associated with burning candles.

It is still yet another object of the present invention to provide such an apparatus and method in which scent emitting properties of the candle can be refreshed.

The above and other objects of the invention are realized in specific illustrated embodiments of an apparatus and method for emitting fragrances from candle wax, wherein the wax is not burned by lighting a wick with a flame. Rather, the candle wax is preferably not provided with a wick, and the wax is melted to cause some of the fragrance to be emitted.

In accordance with one aspect of the invention, a candle heating unit is provided. The candle heating unit has a heating element which is configured to receive a candle and to warm the candle so as to melt the wax. The scent which is mixed with the wax is then released as the wax melts.

In accordance with another aspect of the invention, the candle heating unit is provided with a heat control mechanism. The heat control mechanism enables the user to adjust the heat which is applied to the candle.

In accordance with another aspect of the invention, the candle heating unit is provided with a jar retainer. The jar retainer helps to properly center the jar containing the candle wax and to retain it on the heating element.

In accordance with another aspect of the invention, a light, whether steady or flickering, is disposed adjacent to the jar housing the candle to provide the appearance of a flame, without the risks associated therewith.

The wax in the jar is melted by the heating element. As the wax melts, the wax releases fragrance to provide a pleasant aroma. Because the wax melts without use of a flame, however, there is no smoke, and no release of lead or other toxins. The heating element can be turned on or turned off whenever desired. Additionally, because no flame is used, the risk of fire is virtually eliminated.

In accordance with one method of the present invention, vials of fragrance may be poured on the candle to refresh or modify the scent originally produced by the candle. Unlike burning of a candle, heating a candle in accordance with the principles of the present invention causes much less loss of the candle wax. Typically, only trace amounts of wax is lost each time the candle is used, as opposed to relatively significant amounts as the wax of a traditional scented candle. Additionally, fragrance can be added to the wax to produce the desired fragrance and additional wax can be added as needed.

### BRIEF DESCRIPTION OF THE DRAWINGS

The above and other objects, features and advantages of the invention will become apparent from a consideration of the following detailed description presented in connection with the accompanying drawings in which:

FIG. 1 shows a top view of a candle heating unit formed in accordance with the principles of the present invention;

FIG. 2 shows a perspective view of a candle made in accordance with the principles of the present invention, along with a jar of fragrance;

FIG. 3 shows an alternate embodiment of a candle heating unit with a jar retainer attached thereto;

FIG. 4 shows a top view of yet another alternate embodiment of a candle heating unit made in accordance with the principles of the present invention;

FIG. 5A shows a top view of yet another embodiment of a candle heating unit made in accordance with the present invention;

FIG. 5B shows a side, cross-sectional view of a candle heating unit and a light attachment made in accordance with the present invention; and

FIG. 5C shows a side, cross-sectional view of an alternate embodiment of a candle and heating unit and light attachment made in accordance with the principles of the present invention.

### DETAILED DESCRIPTION

Reference will now be made to the drawings in which the various elements of the present invention will be given numeral designations and in which the invention will be discussed so as to enable one skilled in the art to make and use the invention. It is to be understood that the following description is only exemplary of the principles of the present invention, and should not be viewed as narrowing the pending claims.

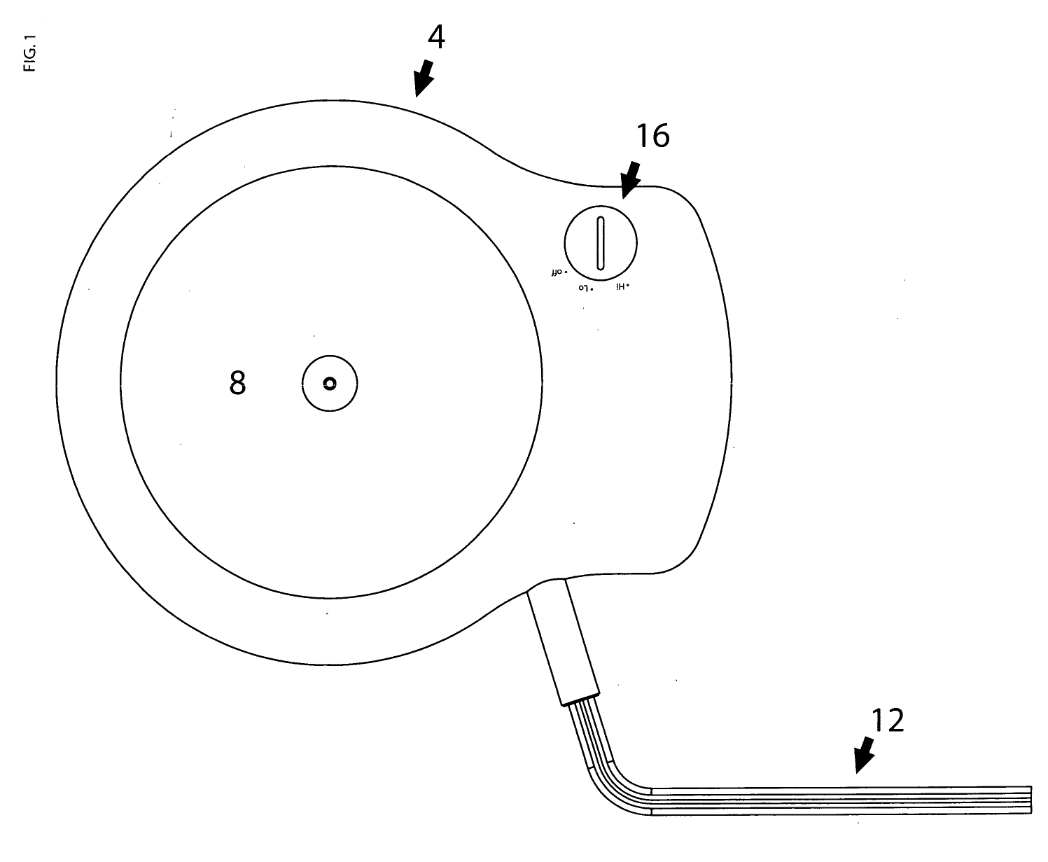

Referring to FIG. 1, there is shown a top view of a candle heating unit, generally indicated at 4, made in accordance with the principles of the present invention. The candle heating unit 4 includes a base 8, which holds the electronics (not show) for the heating element. Disposed on a top side 4a of the candle heating unit 4 is a heating element 8. The heating element 8 is preferably formed by a circular metal plate which is heated from within the candle heating unit 4. However, those skilled in the art will appreciate that a conventional heating element, such as those used on stoves, could also be used.

The heating element 8 of the candle heating unit is preferably sized to be only slightly larger than the base of a candle. Thus, a common diameter for the heating element 8 is about 3.25 inches, although other diameters can be used. Different sized heating elements could also be used with different sized candles.

The candle heating unit also includes a power source, such as an electrical cord 12 for supplying A/C power. If desired, the candle heating unit could be battery powered. However, those skilled in the art will appreciate that generating heat from electricity consumes significant amounts of power, and batters will drain quickly under the load.

In simple versions of the candle heating unit 4, the unit is controlled exclusively by plugging in or unplugging the power cord 12. In more advanced versions, however, a temperature control 16 is provided. The temperature control preferably allows the user to turn the heating element 8 off, or to select between high and low temperatures. By using a higher temperature, the candle wax will melt more quickly and more fragrance will be released. By using a lower temperature, the candle wax will melt more slowly and the level of fragrance can be kept down.

While the on/off function of the candle heating unit 4 is shown to be manual with the temperature control, it can also be performed automatically. For example, the heating element 8 can have a sensor which senses the presence of the candle and turns the heating element on when a candle is positioned on the heating element. When the candle is removed, the heating element 8 automatically shuts off.

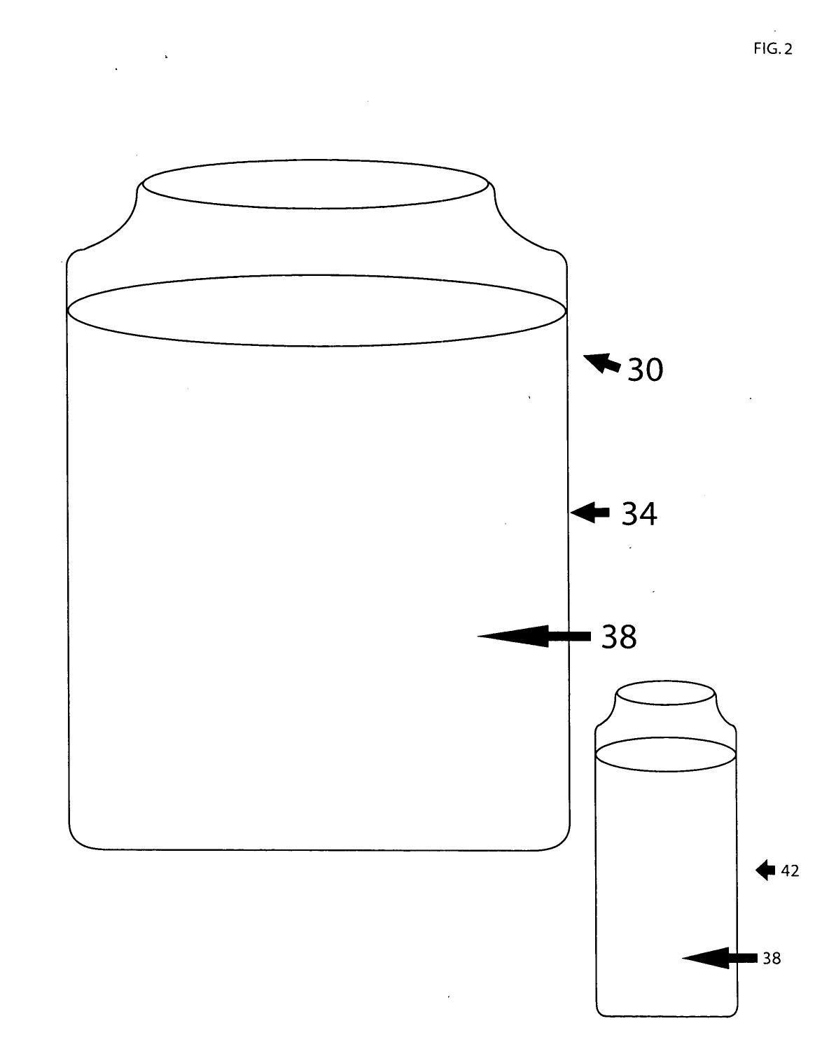

Turning now to FIG. 2, there is shown a perspective view of a candle, generally indicated at 30, made in accordance with the principles of the present invention. The candle 30 includes a glass jar 34 which is filled with fragrance containing candle wax 38. Because the candle is never is never lit, the candle wax 38 does not have wick disposed in the central portion. This is advantageous because some wicks have been found to have toxic chemicals, such as lead, which can be released as the wick burns. By avoiding a wick, such problems are avoided. In light of the present discussion, however, those skilled in the art will appreciate that a conventional scented candle could be used in the manner discussed herein to produce desired aromas.

In accordance with the present invention, the candle 30 is placed on the heating element 8 of the candle heating unit 4. As the heat from the heating element 8 warms the candle wax 38, the fragrance which has been mixed with the candle wax is released to provide the desired aroma.

One advantage of heating the candle from the bottom is that the heat will travel upwardly through all of the wax 34 and soften or liquify the wax. As a very small amount of the wax dissipates, the remaining wax will generally work its way to the bottom of the jar 34. This is in contrast to conventional scented candles where the wax 38 around the wick will often dissipate while wax immediately adjacent the wall of the jar will remain. As the wick burns lower, it is increasingly difficult to light the candle and eventually the candle is discarded with a considerable amount of the wax unburned.

In the present invention, all of the candle wax 38 is heated to release fragrance. In most situations, the wax 38 will have released most of its fragrance well before the wax has dissipated because the wax lasts many times longer than a conventional flame based candle. To prolong the usefulness of the candle, a small jar 42 of fragrance 46 can be poured into the wax 38. If the wax 38 is warm when the fragrance is added, the fragrance and the wax can be mixed to enable the candle 30 to produce the desired aroma for a prolonged period of time. By using such a method, a candle 30 can typically be made to many times as long as a conventional candle.

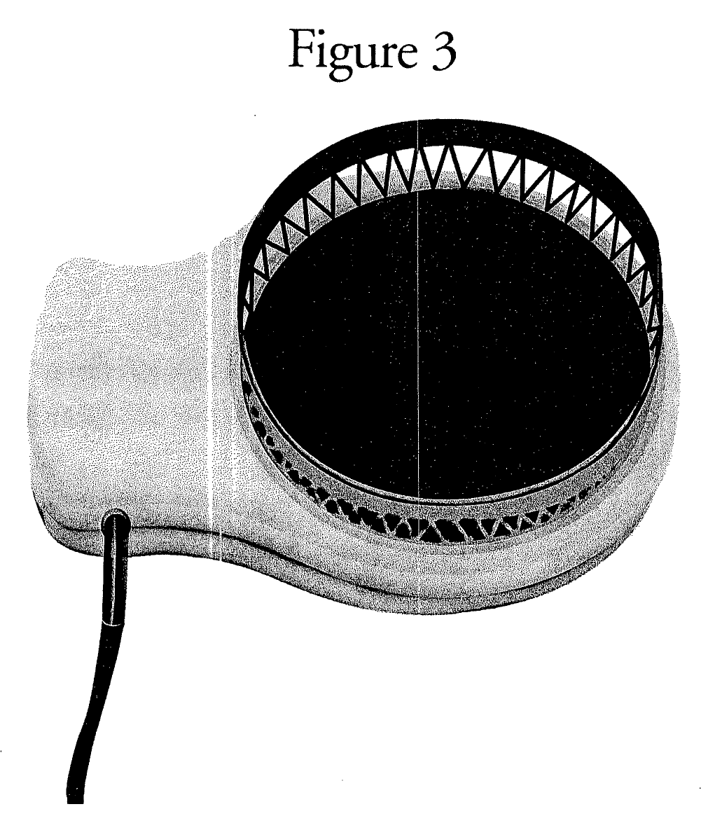

Turning now to FIG. 3, there is shown yet another embodiment of a candle heating unit, generally indicated at 50, made in accordance with the present invention. The candle heating unit 50 has a housing 54 with an annular opening covered by a heating element 58. A power cord 62 is also provided for supplying electricity to the heating element 58.

The heating element 58 is activated by the weight of a candle being placed on the heating element. Those skilled in the art will appreciate that there are numerous ways to accomplish selective activation of the heating element.

Disposed adjacent the heating element 58 is a retaining member 66. Preferably, the retaining member is formed by an annular ring with a plurality of openings 68 formed therein. The retaining member 66 is configured to receive the base of the candle and to hold the candle jar 34 (FIG. 2) over the heating element 58. Because the jar 34 will be filled with softened or liquified wax 38, it is very undesirable for the candle to be slid off the heating element.

While the retaining member 66 is preferably an annular ring, it can also be formed of a plurality of spaced retainers which provide sufficient support to the base of the candle to prevent the candle from being accidentally pushed off the heating element. While the retaining ring may be made of metal, it can also be formed of other materials which will not conduct heat.

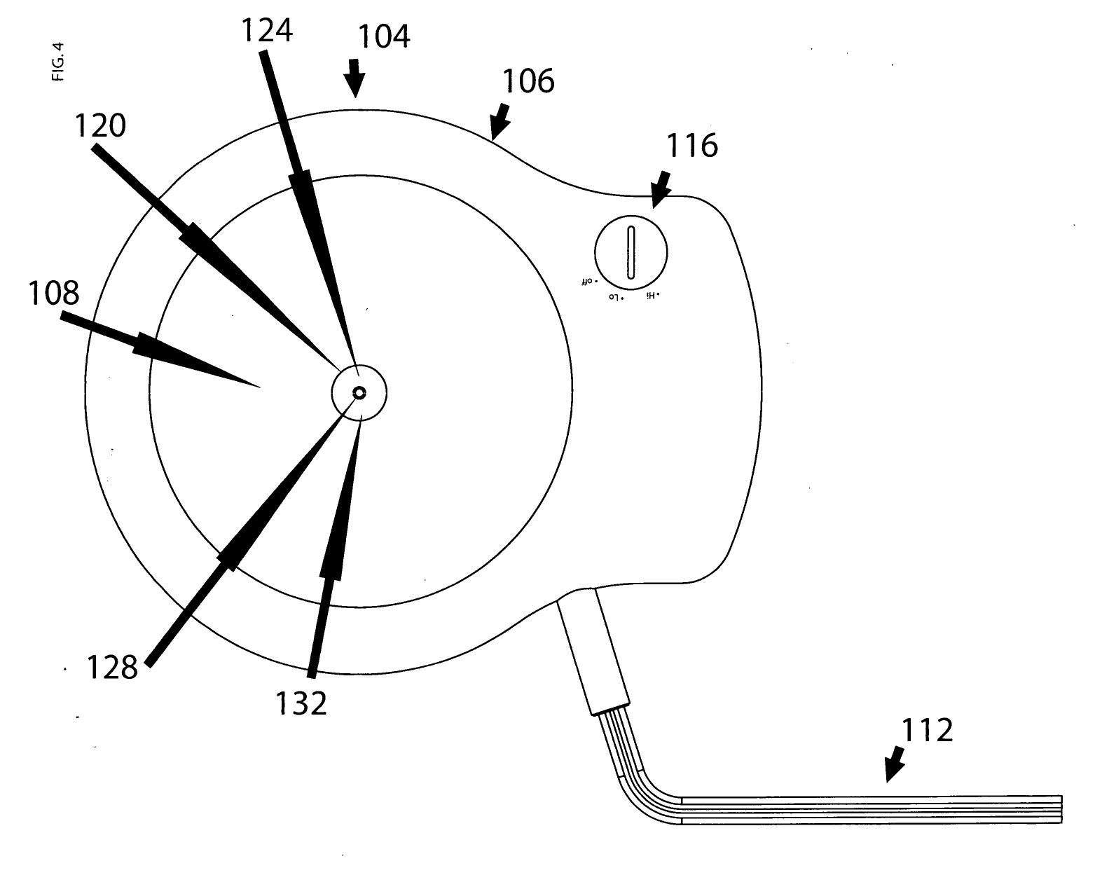

Turning now to FIG. 4, there is shown a top view of another candle heating unit, generally indicated at 104, made in accordance with the principles of the present invention. The candle heating unit 104 has a housing 106 and a heating element 108. A power cord 112 is used to provide electricity to the heating element 108 and other electronics discussed below. A switch 116 preferably is used to control the heating element 108.

Unlike the embodiment discussed regarding FIG. 1, the heating element 108 is generally annular and has an opening 120 formed therein. Disposed in a void 124 below the opening is a light bulb 128 or other light emitting device. A glass cover 132 may be placed over the light bulb 128 to protect it from damage.

The light bulb 128 is used to illuminate a candle disposed on the heating element 120. The amount of illumination provided depends both on the strength of the light, and the transparency of the candle wax. However, as the candle is being warmed and emitting a desired fragrance, the candle can also provide an attractive glow.

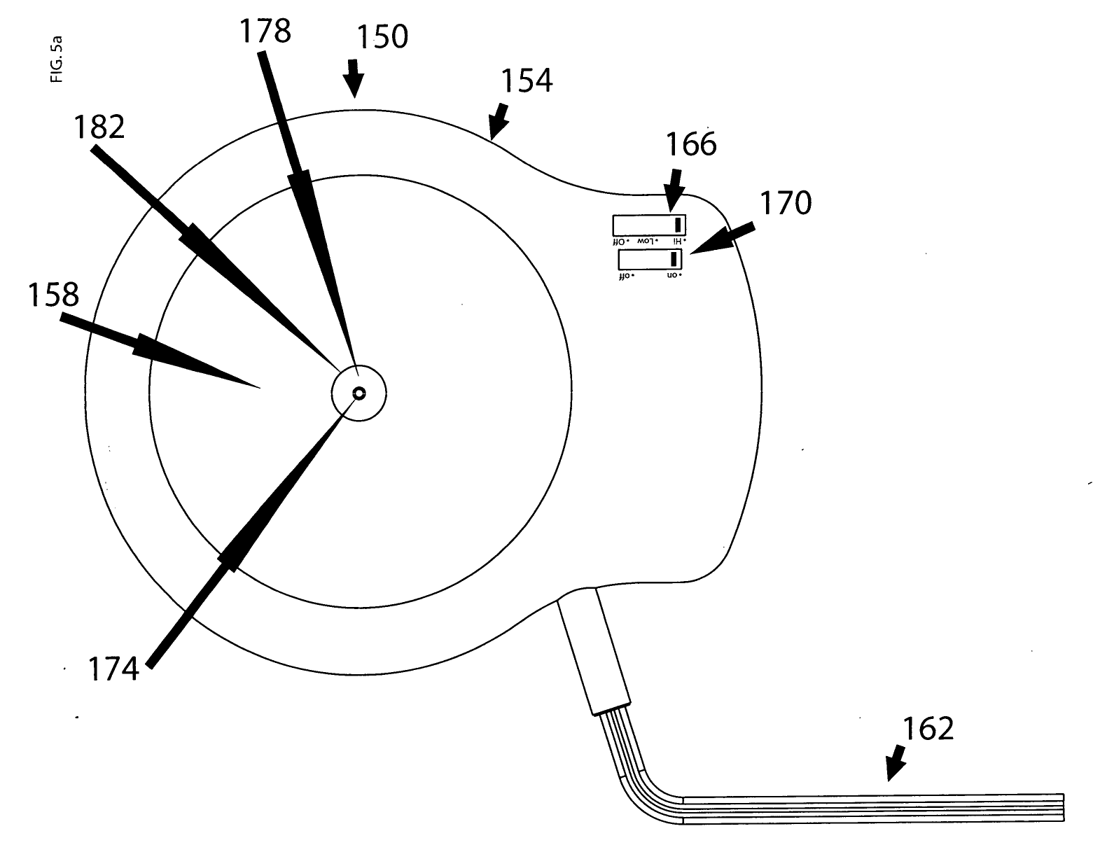

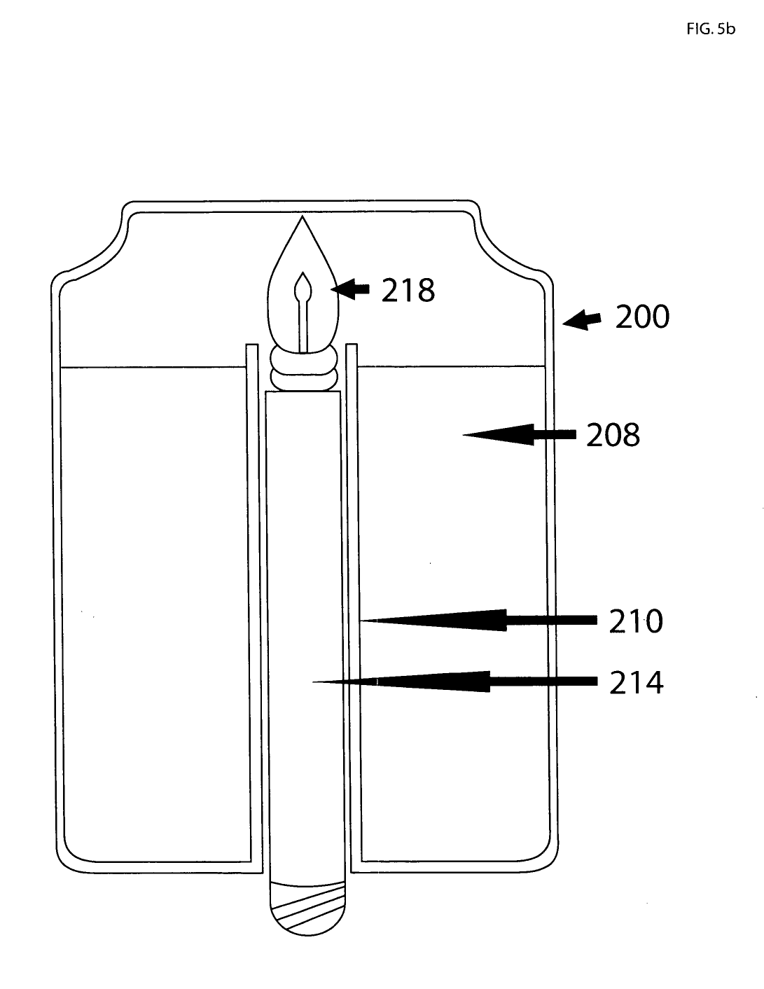

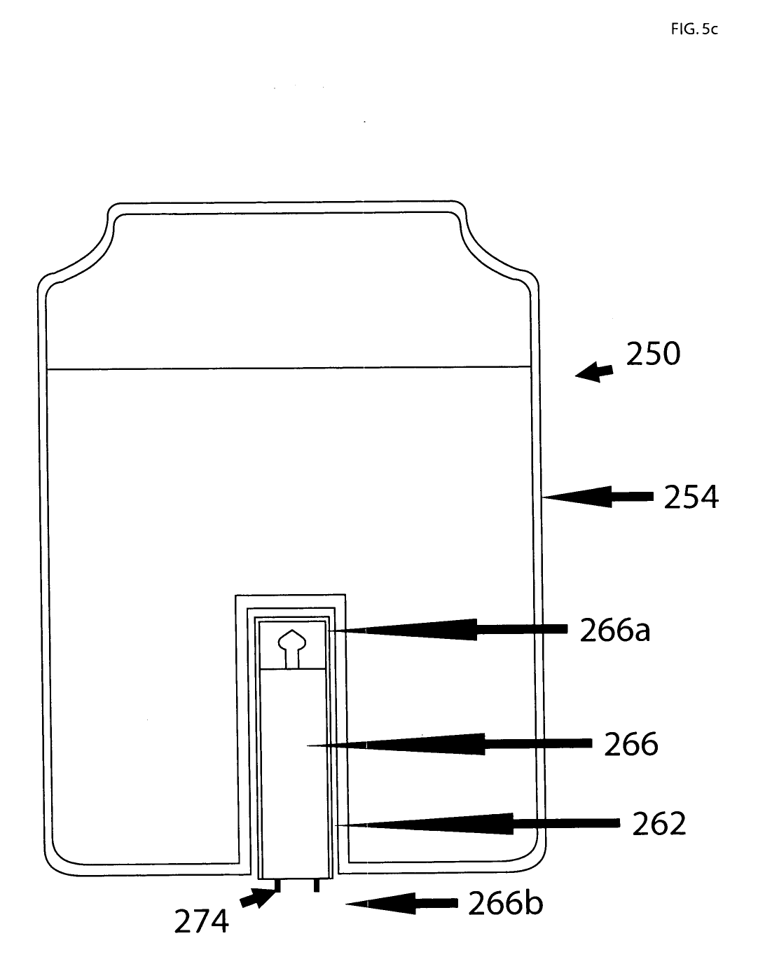

Referring now to FIG. 5A, there is shown yet another candle heating unit, generally indicated at 150. The candle heating unit 150 includes a housing 154 with a heating element 158 and a power cord 162. A first control 166 can be provided to control the heating element, and a second control 170 can be used to control a socket 174 which is disposed in a void 178 disposed below an opening 182 in the heating element 158.

As will be explained in additional detain below, the socket 174 is configured to receive a light attachment so that a light disposed above the candle can be illuminated. By using a flickering light, the candle can be made to appear to burn without the risks associated with burning a flame.

In the alternative, the socket 174 can be used with a light attachment which radiates light from a point between the top and the bottom of the candle. Such a light attachment enables the candle to glow more brightly than a bottom lit candle.

The socket 174 can be configured to screwing in the light attachment, similar to the socket for a conventional light bulb, or can be formed to receive prongs of a power cord, similar to conventional electrical sockets. By selectively using the controls 166 and 170, the user can warm the candle with or without using the light. Likewise, the candle can be made to appear lit while the candle is not being warmed.

FIG. 5B shows a cross-sectional view of a candle, generally indicated at 200 made in accordance with the present invention. The candle 200 includes a jar 204 and candle wax 208 which has fragrance mixed therewith. The jar 204 is unique in that it has a channel 210 extending through the middle of the wax 208. The channel 210 is preferably cylindrical and is formed integrally with the jar 204. However, the channel 210 could be formed separately and attached to the jar 104, and could be any of a variety of shapes.

The channel 210 forms a passageway through the wax 208 so that a light attachment 214 may be inserted into the candle 200. The light attachment includes a lower end 214a which is configured to nest in the socket 174 (FIG. 5B). Once the light attachment 214 is plugged or screwed in, the light 218 will light and give the appearance of a flame flickering.

Those skilled in the art will appreciate that light 218 can be formed to give several different appearances depending on the type of light bulb which is used. By changing light attachments 214, the user is able to give a lighting style which fits his particular mood.

Turning now to FIG. 5C, there is shown a side cross-sectional view of a candle, generally indicated at 250, made in accordance with one aspect of the present invention. The candle 250 includes a jar 254, or other container, an candle wax 258. Because the present invention typically melts all of the candle wax, the user may refill the candle 250 at any time by simply adding candle wax. As the candle 250 is heated, the added candle wax will melt and mix with the candle wax. In the alternative, different candle waxes can be used to form layers. (Those of skill in the art will appreciate that refilling the wax will be rare, as only trace amounts of wax are lost each time the candle is used. This is in contract to a conventional candle which has consume all of the wax within a few hours.)

The jar 254 is formed with a void 262 in the bottom. The void 262 is configured to receive a light attachment 266. An upper end 266a of the light attachment 266 has a light 270. The lower end 266b has a pair of prongs 274 for nesting in a socket, such as socket 174 (FIG. 5A).

In use, the candle 250 is placed on a candle heating unit, such as candle heating unit 150 in FIG. 5A, so that the prongs 274 nest in the socket. The prongs 274 provide power to the light 270 which illuminates the candle wax 258, thereby providing a pleasant appearance. The light 270, of course, may be controlled to provide constant light, flashes of light or any other patterns.

By melting the candle wax 258 to emit fragrance, rather than burning the candle, a considerable amount of fragrance can be emitted, while prolonging the life of the candle. Additionally, wax or fragrance can be readily added while the candle is being “burned” to render the life of the candle virtually infinite.

While several different embodiments of the present invention have been discussed, it should be appreciated that portions of the various embodiments may be combined within the scope of the invention. For example, the retaining member could be used in association with the embodiment providing a socket.

Thus there is disclosed an improved apparatus and method for the flameless “burning” of candles. Those skilled in the art will appreciate numerous modifications which can be made without departing from the scope and spirit of the present invention. The appended claims are intended to cover such modifications.

What is claimed is:

1. A method for emitting fragrance from a candle, the method comprising:
selecting a candle having a container and candle wax without a wick; and
heating the container of candle wax to emit fragrance.

2. The method for emitting fragrance according to claim 1, wherein the method comprises melting all of the wax.

3. The method for emitting fragrance according to claim 1, wherein the method comprises adding additional candle wax to the candle.

4. The method for emitting fragrance according to claim 3, wherein the method comprising adding additional candle wax while the candle wax of the candle is melted.

5. The method for emitting fragrance according to claim 1, wherein the method comprises adding additional fragrance to the candle wax.

6. The method for emitting fragrance according to claim 1, wherein the method further comprises illuminating the candle wax.

7. The method for emitting fragrance according to claim 1, wherein the method further comprised disposing a light attachment in the candle.

8. The method for emitting fragrance according to claim 7, wherein the method comprises disposing a light of the light attachment above the candle wax.

9. The method for emitting fragrance according to claim 1, wherein the method comprises disposing a light below at least a portion of the candle wax.

10. A scented candle comprising;
a container for holding candle wax;
candle wax having fragrance therein;
wherein the candle wax lacks a wick.

11. The scented candle according to claim 10, wherein the candle further comprises a channel formed through a center thereof.

12. The scented candle according to claim 10, further comprising a light attachment disposable at least partially in the candle.

13. A candle heating unit comprising:
a housing;
at least one heating element disposed on the housing for heating a candle; and
at least one socket for providing energy to a light attachment.

14. The candle heating unit of claim 13, wherein the candle heating unit further comprises a light bulb disposed in the socket.

15. The candle heating unit of claim 14, wherein the heating element is disk shaped and wherein the socket is disposed below the heating element.

16. The candle heating unit of claim 13, further comprising light attachment for engaging the socket and emitting light.

17. The candle heating unit of claim 16, wherein the light attachment comprises a socket engagement member for attaching the light attachment to the socket and a means for emitting light.

18. The candle heating unit of claim 16, wherein the light attachment extends upwardly from the heating element.

19. The candle heating unit of claim 13, further comprising a candle configured for resting on the heating element.

20. The candle heating unit of claim 19, wherein the candle comprises a channel formed therein for receiving a light attachment.

21. The candle heating unit of claim 19, wherein the candle comprises a light attachment.

22. The candle heating unit of claim 13, further comprising a control switch for controlling the flow of electricity to the socket.

23. A method for emitting fragrance from a candle, the method comprising;
selecting a candle heating unit having a light attached thereto; and
warming a candle to melt the candle's wax and thereby emit fragrance.

24. The method for emitting fragrance of claim 23, wherein the method comprises emitting light through the candle wax.

25. The method for emitting fragrance of claim 23, wherein the method comprises positioning the light above the candle.

26. The method for emitting fragrances of claim 23, wherein the method comprises positioning the light within the candle.

27. The method for emitting fragrances of claim 23,w herein the method comprises positioning the light below the candle.

28. The method for emitting fragrances of claim 23, wherein the method comprises melting the wax and adding additional wax to the candle.

29. The method for emitting fragrances of claim 23, wherein the method comprises selecting a candle without a wick.

30. The method for emitting fragrances of claim 23, wherein the method further comprises adding fragrance to the wax while the wax is melted.

31. A candle heating unit comprising:
a housing;
at least one heating element disposed on the housing for heating a candle; and
a candle retaining member disposed adjacent to the at least one heating element for holding a candle thereon.

32. The candle heating unit according to claim 28, wherein the candle retaining member comprises an annular ring.

33. The candle heating unit according to claim 28, further comprising at least one light attachment.

34. The candle heating unit according to claim 30, wherein the at least one light attachment comprises a light bulb disposed at least partially below the heating element.

35. The candle heating unit according to claim 30, wherein the at least one light attachment extends above the heating element.
